(19) United States
(12) Patent Application Publication
(10) Pub. No.: US 2002/0137459 A1
(43) Pub. Date: Sep. 26, 2002

(54) Network and method for transmitting messages on a common wireless resource without causing broadcast storm

(76) Inventors: Koichi Ebata, Tokyo (JP); Hiroshi Furukawa, Tokyo (JP); Morihisa Momona, Tokyo (JP)

Correspondence Address: McGinn & Gibb, PLLC, Suite 200, 8321 Old Courthouse Road, Vienna, VA, 22182-3817, US

(21) Appl. No.: 10/100,912

(22) Filed: Mar. 20, 2002

(30) Foreign Application Priority Data
Mar. 21, 2001 (JP) 2001-080465

(51) Int. Cl. H04B 7/14

(52) U.S. Cl. 455/16; 455/7; 370/328; 370/312

(57) ABSTRACT

In a multi-hop wireless communication network where network nodes are interconnected by a common wireless resource, a source node formulates a message containing first and second address fields and a data payload field. The first address field identifies a neighbor node on a destination side of the network node and the second address field identifies a neighbor node on a source side of the network node, and transmits the message toward a destination. Each transit node discards the message depending on; at least one of the first and second address fields of the message, updates the first and second address fields according to neighbor nodes of the transit node, and broadcasts the message using the common wireless resource.

### BACKGROUND OF THE INVENTION

1. Field of the Invention

The present invention relates generally to wireless communication networks, and more specifically to a technique for preventing broadcast storm in a multi-hop wireless communication network where messages are broadcast on a common wireless resource.

2. Description of the Related Art

In a multi-hop wireless communication network of the type where network nodes are interconnected by a wireline system and mobile nodes connect to the network nodes by a wireless access system, a broadcast message from a mobile node is relayed from one network node to the next via the wireline system, while at the same time the message is broadcast at one-hop intervals from each network node to its mobile nodes via the wireless access system. As the point of broadcast is moved from one network node to the next, the message is broadcast to the mobile nodes in the serving area of the network node. Even if the broadcast signal goes beyond the serving area of a network node, it is never broadcast again by a neighbor node. In the wireless network of this type, wireless broadcasting terminates at one-hop intervals.

On the other hand, in a multi-hop wireless communication network of the type where network nodes are not interconnected by wireline systems but share the same frequency (common wireless resource) with mobile nodes for message transfer, each network node is required to repeat transmission of a message received on an intended path regardless of the direction of transmission, but required to discard a message received on an unintended path. Each network node is able to obtain the source and destination of a message from its address fields, but unable to identify its direction of transmission. When a message is broadcast by a given node, it is received by a neighbor node and broadcast again. Since the broadcast signal propagates in all directions, it is detected by the given node and broadcast again in all directions, Since this process repeats indefinitely, the network is overwhelmed by a vast number of broadcast messages, causing what is known as a broadcast storm.

Broadcast messages may be transmitted in a unicast transfer mode to mobile terminals whose access routes are established. However, this unicasting method does not properly function in a network such as cellular mobile telephone network where there is uncertainty as to the location of some mobile terminals. No broadcast messages are transmitted to the mobile terminals whose location is unknown to the network.

### SUMMARY OF THE INVENTION

It is therefore an object of the present invention to provide a system and a method for multi-hop wireless networks in which broadcast messages are transmitted on a common wireless resource without causing a broadcast storm.

According to the general aspect of the present invention, there is provided a multi-hop wireless communication network comprising a plurality of network nodes interconnected by a common wireless resource. Each of the network nodes, when functioning as a source node, formulates a message containing first and second address fields and a data payload field. The first address field identifies a neighbor node on a destination side of the network node and the second address field identifies a neighbor node on a source side of the network node, and transmits the message toward a destination. Each of the network nodes, when functioning as a transit node, discards the message depending on at least one of the first and second address fields of the message, updates the first and second address fields according to neighbor nodes of the transit node, and broadcasts the message using the common wireless resource.

According to a first aspect, the present invention provides multi-hop wireless communication network comprising a plurality of network nodes for establishing a wireless link between neighboring network nodes over a common wireless resource. Each of the network nodes, when functioning as a source node, broadcasts a first message and unicasts a second message. Each network node, when functioning as a transit node, receives the first and second messages, discards the received first message, produces a copy of the first message from the received second message, broadcasts the copy of the first message, and unicasts the received second message. First messages transmitted in broadcast transfer mode from each transit node move along the paths specified by the second messages transmitted in unicast transfer mode. Since the first messages are discarded at one-hop intervals, no broadcast storm occurs.

According to a second aspect of the present invention, there is provided a multi-hop wireless communication network comprising a plurality of network nodes for establishing a wireless link between neighboring network nodes over a common wireless resource, each of the nodes being identified by an address. Each of the network nodes, when functioning as a source node, broadcasts a message containing a previous hop address. Each network node, when functioning as a transit node, receives the message, discards it if the previous hop address of the received message is equal to the address of the transit node or updates the previous hop address with the address of a previous node if the previous hop address is not equal to the address of the transit node. The updated message is then broadcast.

According to a third aspect of the present invention, there is provided a multi-hop wireless communication network comprising a plurality of network nodes of a tree topology configuration for establishing a wireless link between neighboring network nodes over a common wireless resource, each of the nodes being identified by an address, and one of the nodes being a root node. Each of the network nodes, when functioning as a source node, unicasts a message toward the root node containing a unicast address. Each network node, when functioning as a branch node, updates he unicast address of the unicast message and unicasts the updated message toward the root node. The root node is responsive to the message from the branch node for updating the message with a broadcast address and the address of the root node, and broadcasts the updated message, The branch node receives the broadcast message, updates the broadcast message with the address of the branch node and broadcasts the updated message.

According to a fourth aspect, the present invention provides a multi-hop wireless communication network comprising a plurality of network nodes for establishing a wireless link between neighboring network nodes over a common wireless resource, each of the nodes being identified by an address. Each network node, when functioning as a source node, unicasts a message containing a unicast address, each of the network nodes, when functioning as a transit node, receives the message, update the unicast address of the message with the address of a next node if the transit node is other than a leaf node and unicasts the updated message to the next node, updates the unicast address of the received message with a broadcast address if the transit node is a leaf node and broadcasts the updated message, The transit node discards the received message if the transit node is a neighbor of the leaf node.

### BRIEF DESCRIPTION OF THE DRAWINGS

The present invention will be described in detail further with reference to the following drawings, in which;

FIG. 1 is a block diagram of a multi-hop wireless communication network incorporating a number of embodiments of the present invention;

FIG. 2 is an illustration of a message format used in the first, third and fourth embodiments of the present invention;

FIG. 3 is a flowchart of the operation of a sending node of thy network according to the first embodiment of the present invention;

FIG. 4 is an illustration of a typical example of a routing table, maintained by a base node of the network;

FIGS. 5A and 5B are illustrations of address and payload data contained in the messages of different types transmitted from a sending node according to the flowchart of FIG. 3;

FIG. 6 is a flowchart of the operation of a transit (repeater) node of the network according to the first embodiment of the present invention;

FIGS. 7A and 7B are illustrations of address and payload data contained in the messages transmitted from a transit node according to the flowchart of FIG. 6;

FIG. 8 is a flowchart of the operation of a receiving mobile node according to the first embodiment of the present invention;

FIG. 9 is a schematic diagram for illustrating messages transmitted through the network according to the first embodiment of the invention;

FIG. 10 is an illustration of a message format used in the second embodiment of the present invention;

FIG. 11 is a flowchart of the operation of a sending node according to the second embodiment of the invention;

FIG. 12 is a flowchart of the operation of a transit node according to the second embodiment of the present invention;

FIG. 13 is a schematic diagram for illustrating messages transmitted through the network according to the second embodiment of the invention;

FIG. 14 is a flowchart of the operation of a sending node according to the third embodiment of the present invention;

FIG. 15 is a flowchart of the operation of a transit node according to the third embodiment of the present invention;

FIG. 16 is a schematic diagram for illustrating messages transmitted through the network according to the third embodiment of the invention;

FIG. 17 is a flowchart of the operation of a sending node according to the fourth embodiment of the present invention;

FIG. 18 is a flowchart of the operation of a transit node according to the fourth embodiment of the present invention;

FIG. 19 is a flowchart of the operation of a receiving mobile node according to the fourth embodiment of the present invention; and

FIG. 20 is a schematic diagram for illustrating messages transmitted through the network according to the fourth embodiment of the invention.

### DETAILED DESCRIPTION

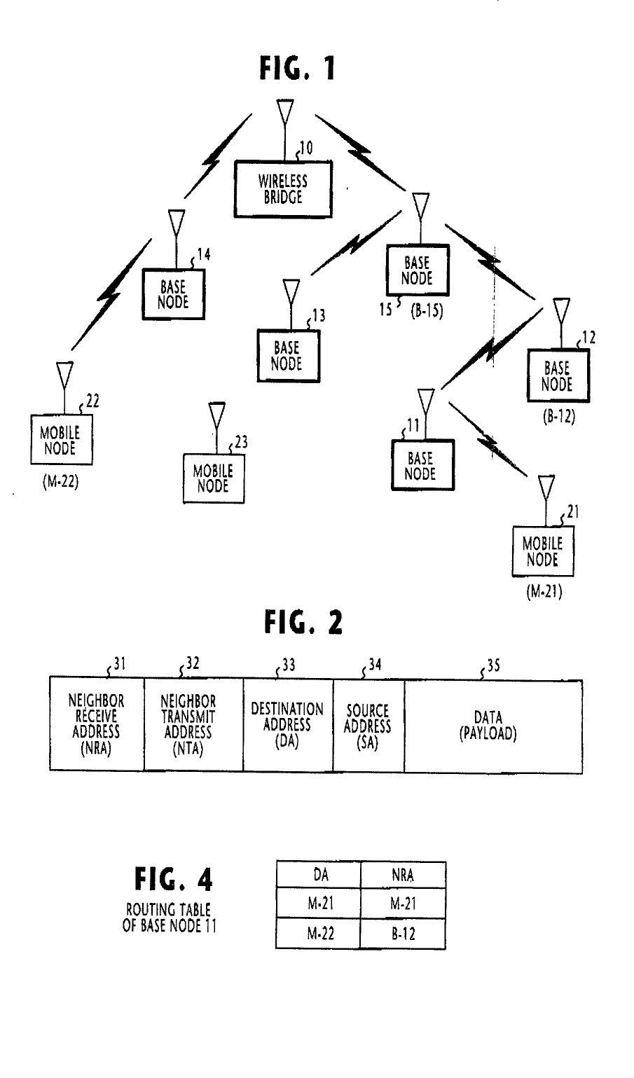

Referring now to FIG. 1, there is shown a multi-hop wireless communication network which operates according to a number of embodiments of the present invention. The multi-hop wireless communication network is comprised of a plurality of nodes, including a wireless bridge 10 (which functions as a root node in a tree topology which uses the spanning tree algorithm), base nodes 11 to 15 and mobile nodes 21 to 23. In the network configuration of FIG. 1, nodes located on the near side of a given node to the root node 10 are upstream nodes of the given node and nodes on the far side of the given node are downstream nodes of the given node. Wireless bridge 10 and all base nodes operate as message sending nodes as well as transit nodes for relaying messages received from an upstream node (or upstream neighbor) to a downstream node (or downstream neighbor). All nodes of the network are interconnected by wireless links of a common resource for relaying messages from one node to the next. Base nodes 11, 13 and 14 are leaf nodes because they are termination points of the network. All nodes of the network are assigned a unique node address.

In the illustrated example, the mobile nodes 21 and 22 are in communication with the base nodes 11 and 14, respectively, and the mobile node 23 is in a standby mode ready to receipt a request from the network to establish a wireless link to the base node 13.

As shown in FIG. 2, the broadcast message transported over file network of FIG. 1 is comprised of a plurality of fields including a neighbor receive address (NRA) field 31, a neighbor transmit address (NTA), field 32, a destination address (DA) field 33, a source address (SA) field 34 and a data payload field 35.

The layer on which the messages are transported sits within the datalink layer of the OSI seven-layer reference model, or sits between the IP and MAC layers of the internet protocol and is able to cooperate with the MAC layer. In such instances, the neighbor transmit address (NTA) and the neighbor receive address (NRA) are MAC addresses of the MAC layer and the destination address (DA) and the source address (SA) are MAC addresses of an upper layer.

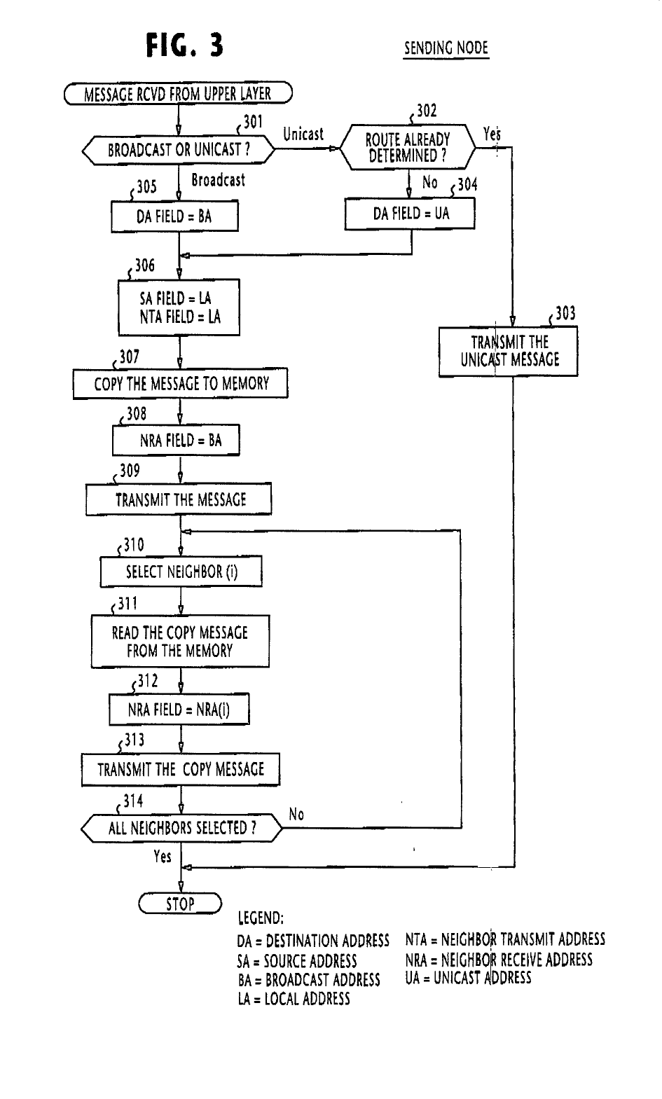

The following is a description of a first embodiment of the present invention with reference to FIGS. 3 to 8.

The flowchart shown in FIG. 3 illustrates the operation of all mobile nodes and base nodes when they receive a broadcast message or unicast message from an upper layer to complete the message by setting appropriate address data into the address fields of the message and forward it onto the network for transmission over the common wireless resource. The message received from the upper layer contain no data in its address fields.

When a message is received from the upper layer, the sending node determines as to the type of message at step 301. If the received message is a unicast message, flow proceeds to decision step 302 to determine whether the route to its destination has already been determined. If this is the case, flow proceeds to step 303 to transmit the unicast message from the antenna to the network along the known route. If the route has not been determined for the unicast message, a unicast address (UA), which has been communicated from the upper layer, is set into the DA field of the message at step 304. For example, consider a case in which the upper layers has been in unicast communication with a remote layer while the cached routing information has expired its timeout period and rendered invalid. Thus, the upper layer still has the knowledge of destination but has lost the knowledge of the established route.

If step 301 has determined that the received message is a broadcast message, a broadcast address (BA) is set into the DA field of the message at step 305.

Following steps 304 and 305, step 306 is executed by setting the node address of the sending node as a local address (LA) into the SA (source address) and NTA (neighbor transmit address) fields of the message.

At step 307, the message is copied and saved in a memory, while flow proceeds to step 308 to set the broadcast address into the NRA (neighbor receive address) field of the original message, which is then transmitted from the antenna to the network at step 309. Thus, the copy message stored in the memory remains unchanged, leaving its NRA field blank.

The neighbor (i) located on one of a plurality of routes the sending node has to the broadcast destination is selected (step 310). Then, the stored copy message is read out of the memory (step 311) and the address of the downstream neighbor (NRA) of the selected route is set into the NRA field of the read copy message (step 312), completing a message. The copy message is then transmitted from the antenna to the network (step 313). If more than one route is available, steps 310 to 313 are repeated until the neighbors on all broadcast destination routes are selected and copy messages are transmitted (step 314).

As a result, if the message requested from the upper layer is a broadcast message, a single broadcast message (type-1 message) is transmitted to the network on a broadcast transfer mode and one or more broadcast copy messages (type-2 message) are transmitted on a unicast transfer mode. If the message requested from the upper layer is a unicast message whose route has yet to be determined, a single unicast message (type-3 message) is transmitted to the network on a broadcast mode and one or more unicast copy messages (type-4 message) are transmitted on a unicast mode.

Each base node has a routing table. For example, if the mobile node 21 is a sending node, the base node 11 maintains a routing table as shown in FIG. 4. If the mobile nodes 21 and 22 are destination nodes, the node addresses M-21 and M-22 of mobile nodes 21 and 22 will be mapped to the nose address M-21 of mobile node 21 and the node address B-12 of base node 12, respectively, as the downstream neighbor nodes of base node 11. Each transit or repeater node of the network references to the routing table to determine the next hop.

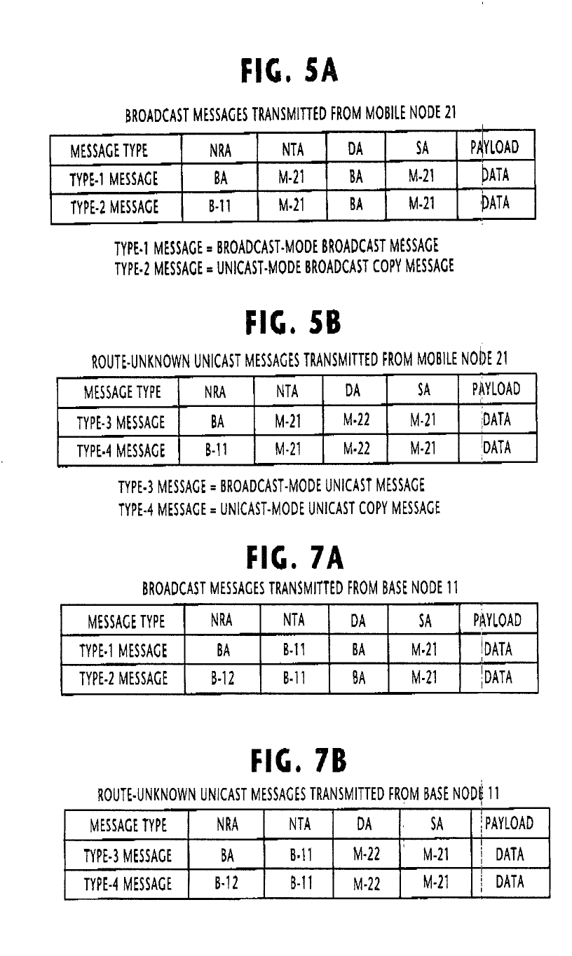

Therefore, if the mobile node 21 transmits a broadcast message, it will be sent on a broadcast mode (type-1 message), containing address data BA, M-21, BA and M-21 in the NRA, NTA, DA and SA fields, respectively, as shown in FIG. 5A and a broadcast copy message (type-2 message) will be sent on a unicast mode, containing address data B-11, M-21, BA and M-21 in the NRA, NTA, DA and SA fields, respectively.

Additionally, if the mobile node 21 transmits a unicast message to the mobile node 22 and the route to that node is lost or unknown, it will be sent on a broadcast mode (type-3 message), containing address data BA, M-21, M-22 and M-21 in the NRA, NTA, DA and SA fields, respectively, as shown in FIG. 5B and a unicast copy message (type-4 message) will be sent on a unicast mode, containing address data B-11, M-21, M-22 and M-21 in the NRA, NTA, DA and SA fields, respectively.

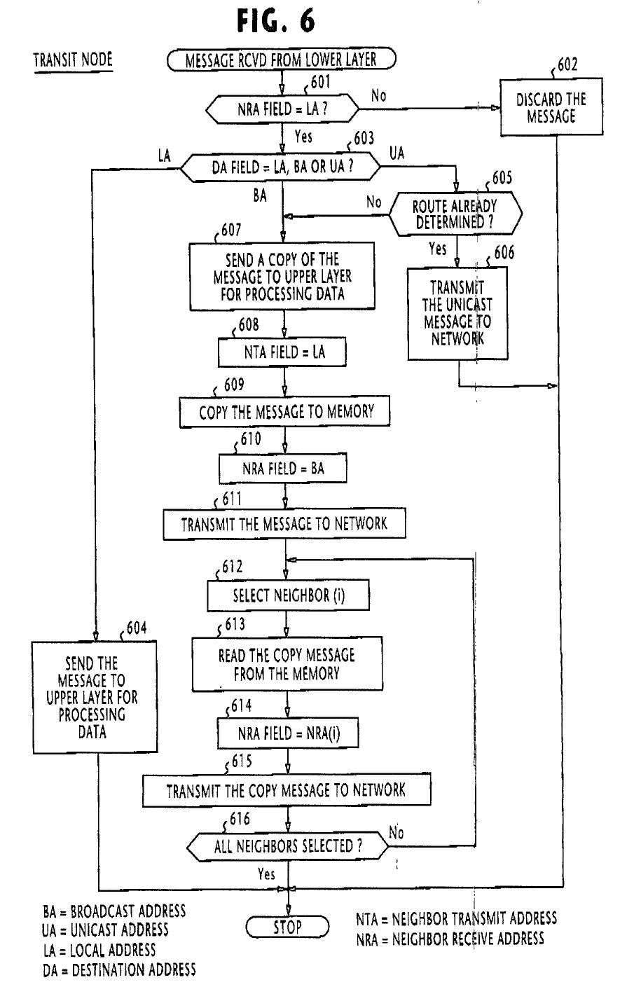

The messages transmitted from the sending node are received by the physical layer of a transit base node. In response to receipt of a message by the lower layer, the transit base node operates according to the flowchart of FIG. 6. At step 601, the transit node examines the NRA (neighbor receive address) field of the message and determines if it matches the local address (LA) of the transit node. If the received message is a broadcast message or a message addressed to another node, the decision is negative at step 601, and flow proceeds to step 602 to discard the message and terminates the routine. If the local address of the transit node is detected (step 601), flow proceeds to step 603 to examine the DA field of the message. If the local address of the transit node is detected in the DA field, the message is a unicast message and sent to the upper layer for processing the data contained in the payload field of the message (step 604) and the routine is terminated. If a unicast address is detected in the DA field, flow proceeds to step 605 to determine if the route to the destination has already been determined. If so, flow proceeds to step 606 to transmit the unicast message to the network along the known route.

If the transit node has determined that the route of the unicast message is unknown (step 605) or the broadcast address is detected in the DA field of the message, flow advances to step 607 to send a copy of the received message to the upper layer for processing the data contained in the payload field of the message. At step 608, the local address (LA) of the transit node is set into the NTA (neighbor transmit address) field of the received message and the message is copied and saved in a memory (step 609).

At step 610, the broadcast address is set into the NRA (neighbor receive address) field of the original messages leaving the copy message unchanged, The message containing the updated NRA field is then transmitted to the network at step 611. Step 612 selects a neighbor (i) on one of all broadcast destination routes from the transit node except the one on which it has received the message, and step 613 reads the stored message from the memory. Step 614 sets the address of the downstream neighbor (NRA) of the selected route into the NRA field of the read copy message, overwriting the content of the received message, The copy message is then transmitted to the network (step 615). If more than one route is available, steps 612 to 615 are repeated until all copy messages are transmitted from the transit node to the neighbors of all broadcast destination routes (step 616).

Therefore, in the transit node, the NTA field of the broadcast-mode broadcast message of FIG. 5A is updated with the address B-11 of base node 11 as shown in FIG. 7A, and the NRA and NTA fields of the unicast-mode broadcast copy message are updated with the addresses B-12 any B-11 of base nodes 12 and 11, respectively. Further, the NTA field of the broadcast-mode unicast message of FIG. 5B is updated with the address B-11 if base node 11 as shown in FIG. 7B and the NRA and NTA fields of the unicast-mode unicast copy message are updated with the addresses B-12 and 11 of base nodes 12 and 11, respectively.

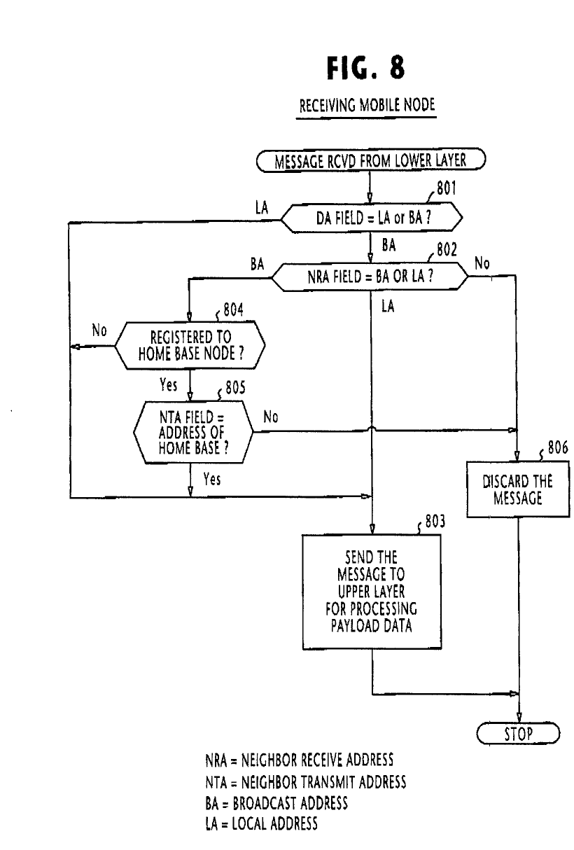

In FIG. 8, when a mobile node receives a message of either type, the DA field of the message is examined at step 801. If the DA field matches the local address of the mobile node, it its determined that the message is a unicast message and flow proceeds to step 804 to sent the message to the upper layer for processing the payload data. If the DA field matches the broadcast address, the message is determined as a broadcast message and the NRA field of the message is examined at step 802. If the NRA field matches the broadcast address, flow proceeds to step 805 to determine if the mobile node has been registered in a home base node. If not, the message is sent to the upper layer (step 803). If the mobile node has been registered in a base node, the NTA field is examined at step 805 to determine if it matches the address of the home base node. If the decision is negative, flow proceeds to step 806 to discard the message. If the NRA field matches the local address at step 802, flow proceeds to step 803 to send the message to the upper layer,

In this way, broadcast messages can reach any mobile node of the network. If an accessed mobile node is in a standby state such as mobile node 23 (FIG. 1), the broadcast message will alert it to establish a link to the base node 13 to receive the broadcast message.

If a unicast-mode message is received following the receipt of a broadcast-mode message, the receiving mobile node will advances through steps 801 and 802 to step 802 to send the unicast-mode message to the upper layer. The upper layer recognizes that this message is identical to the broadcast-mode message it has received previously, and discards the later arriving message.

If the receiving node detects its own local address in the NRA field, flow proceeds to step 802 to determine whether the receiving node has already received a broadcast message. If so, it is determined that the currently received message is a unicast-mode broadcast message and flow proceeds to step 805 to discard this message. If the decision is negative at step 802, flow proceeds to step 803 to determine whether the address contained in the NTA field of the message corresponds to the neighbor of the receiving mobile node to which it belongs. If the decision is affirmative at step 803, the received message is sent to the upper layer (step 804). If the decision at steps 801 and 803 is negative, the message is discarded (step 805).

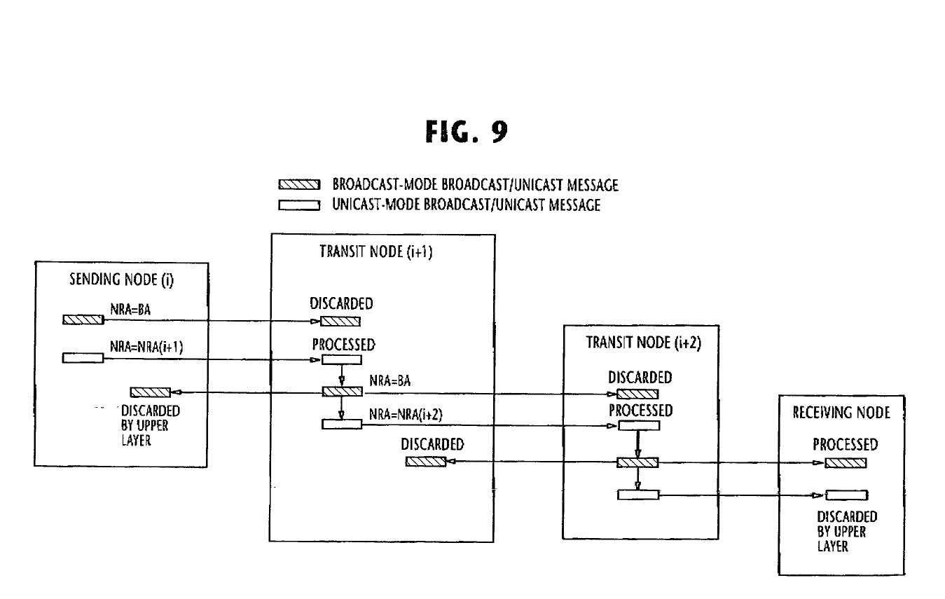

As schematically shown in FIG. 9, as a broadcast-mode message and a unicast-mode message propagate through the network, each broadcast-mode message is discarded at one-hop intervals by each transit node and a new broadcast-mode message is created from the corresponding unicast-mode message for transmission to the next.

At each transit node, a copy of the unicast-mode message is sent to the upper layer for processing its payload data and the address data of the original unicast-mode message is updated for transmission to the next. The process is repeated until the broadcast-mode message is processed by a receiving mobile node and the unicast-mode message is discarded by the upper layer of the mobile node. In is way, broadcast messages can be reliably sent to all nodes of the network.

As is seen from FIG. 9, when a broadcast message is initially transmitted to the network, the sending node receives the same message from the neighbor receive node. However, the upper layer of the sending node discards this message, recognizing that it is a returning version of message it has transmitted to the neighbor. As broadcast-mode and unicast-mode messages are propagated through the network, each neighbor transmit node discards a returning version of the message it has transmitted to the neighbor receive node. Broadcast storm is prevented in this way. At the receiving node, the upper layer of the node processes the broadcast-mode message and discards the unicast-mode message.

Since the transit node creates a new broadcast-mode message by copying from the unicast-mode message, the broadcasting of copied messages from successive transit nodes occurs only along intended routes. In the prior art wireless network, broadcast messages propagate not lay along intended routes, but along unintended routes, quickly flooding the network.

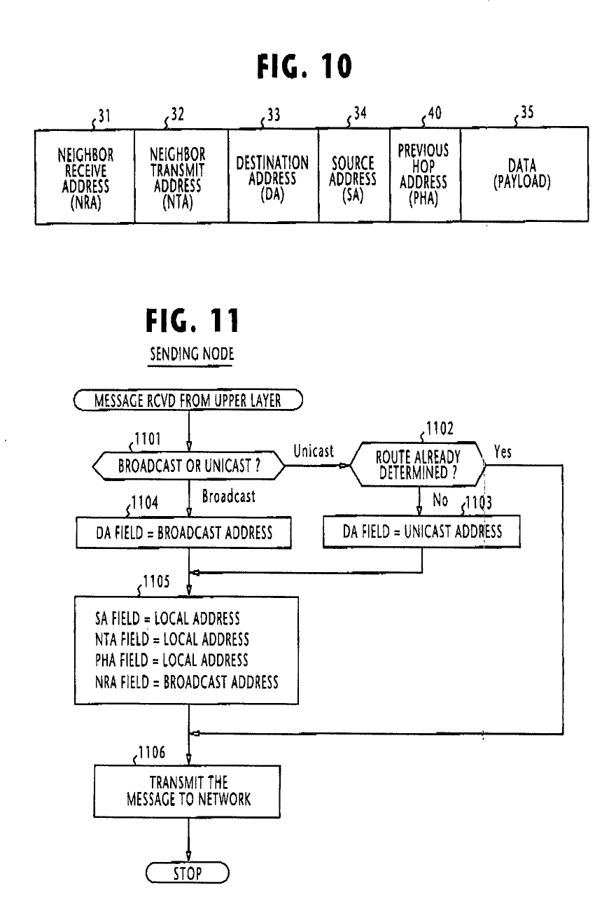

A second embodiment of the present invention is shown in FIGS. 10, 11 and 12. As shown in FIG. 10, the message used in the second embodiment additionally includes a previous hop address (PHA) field 45. PHA field 45 will be set with the address of an upstream neighbor node that has immediately caused the transmission of a broadcast message. If the base node 11 has received a broadcast message from the base node 12 (FIG. 1), the base node 11 will updates its PHA field with the local address B-12 of base node 12. Being absent of an upstream neighbor node, the first node of a broadcast message sets its own local address into the PHA field.

In FIG. 11, the routine of a sending node of the network begins when a message is received from an upper layer. At decision step 1101, the sending node determines if the received message is a broadcast or a unicast message. If the message is a unicast message, flow proceeds to step 1102 to check to see if the route to the destination has already been determined. If so, be unicast message is transmitted to the network (step 1106). Otherwise, a unicast address is set into the DA field of the message at step 1103. On the other hand, if the message from the upper layer is a broadcast message, a broadcast address is set into the DA field (step 1104).

At step 1105, the sending node sets the local address of the sending node into the SA, NTA and PHA fields of the message and the broadcast address into the NRA field, and proceeds to step 1106 for transmitting the broadcast message to the network. The transmitted messages are received by the lower layer of a transit node.

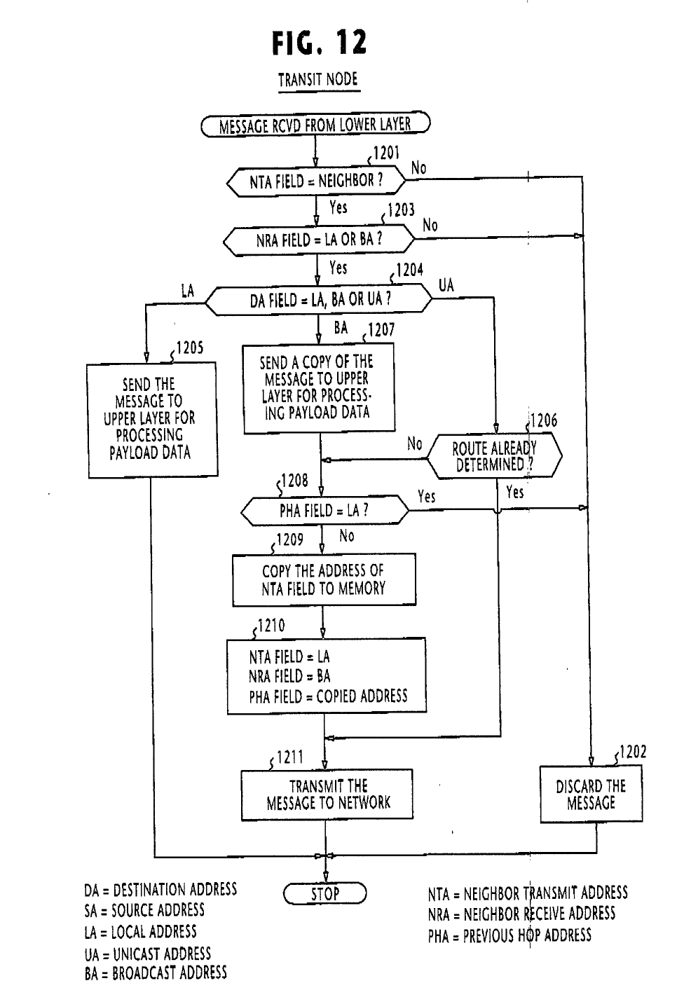

In FIG. 12, when the transit node receives a message from the lower layer, it examines the NTA (neighbor transmit address) field of the message at step 1201 to check for coincidence with the address of a neighbor node located on a predetermined route to the transit node. If it is determined that the message has arrived from a node other than its neighbors, the message is discarded (step 1202). If the message is determined as having arrived from an upstream or a downstream neighbor, the decision at step 1201 is affirmative and flow proceeds to step 1203 to check for correspondence between the NRA field and the local address (LA) or broadcast address (BA). If the decision is negative at step 11-3, the message is discarded (step 1202).

If the message matches BA or LA in its NRA field, flow proceeds from step 1203 to step 1204 to check to see if the DA field matches LA (local address), BA (broadcast address) or UA (unicast address). If DA=LA, the message is sent to the upper layer for processing the payload data (step 1205). If DA=UA, step 1206 determines if a route has already been determined for the received message. If so, the message is transmitted to the network (step 1211). Otherwise, the routine proceeds to step 1208.

If DA=BA (step 1204), the transit node proceeds to step 1207 to send a copy of the received message to the upper layer for processing the payload data, and proceeds to decision step 1208.

Decision step 1208 determines whether the PHA field matches the local address (LA) of the transit node. If they match, the message is discarded (step 1202). With the received message being discarded when PHA LA, the transit node is prevented from repeatedly transmitting the same broadcast message upon receipt of a returning version of its broadcast message from the neighbor node. Consequently, the occurrence of a broadcast storm is prevented. If the PHA field mismatches the local address, flow proceeds to step 1209 where the NTA field of the received message is copied to memory (step 1209). At step 1210, the transit node sets is local address into the NTA field, the broadcast address into the NRA field and the copied address in the memory into the PHA field. The DA and SA fields are not altered. Flow proceeds from step 1210 to step 1211 to transmit the updated message to the network.

When the mobile nodes of the network receive the messages transmitted according to the flowchart of FIG. 12, the same process as described in connection with FIG. 8 is repeated.

If the mobile node 21 has transmitted a broadcast message to the base node 11, the latter determines whether the message has been transmitted from its neighbor. Since NRA=BA (step 1203), the base node 11 recognizes that the message is a broadcast message. Since PHA is not equal to LA (step 1208), the base node 11 copies the M-21 address of mobile node 21 contained in the NTA field to memory (step 1209) and sets NTA=B-21, NRA=BA and PHA=M-21 (step 1210). Thus, following receipt of a broadcast message from a neighbor node, each base node updates the PHA field of the message with the address of the neighbor before the base node sends it to the network. As a result, broadcast storm is prevented.

Additionally, since each transit node determines whether the node from which it has received a broadcast message is a neighbor located on a specified route to the destination (step 1201), broadcast messages arriving on unspecified routes are discarded by the transit node. This procedure has the effect of preventing broadcast messages from being unnecessarily forwarded to the network.

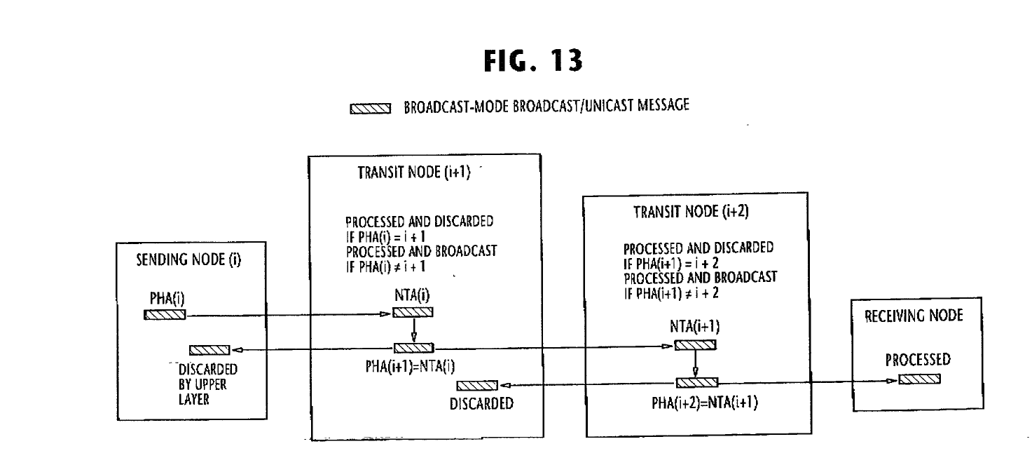

As shown in FIG. 13, the second embodiment of this invention makes exclusive use of broadcast-mode messages by updating the PHA field of an outgoing message with the NTA field of an incoming message. When a broadcast message is initially transmitted from a sending node (i) to the network, the message is discarded if the node that received the message is not a neighbor of the sending node. If that receiving node is a neighbor of the sending node, the message is processed, and then discarded if the PHA field matches the local address (steps 1208, 1202) or the PHA and NTA fields of the message are updated if they mismatch and the updated message is transmitted (steps 1208 to 1211). The sending (i) receives the same message from the neighbor node (i+1). However, the upper layer of the sending node discards this message, recognizing that it is a returning version of the message it has transmitted to the neighbor receive node. As broadcast messages are propagated through the network, each neighbor transmit node discards a returning version of the message it has transmitted to the neighbor receive node.

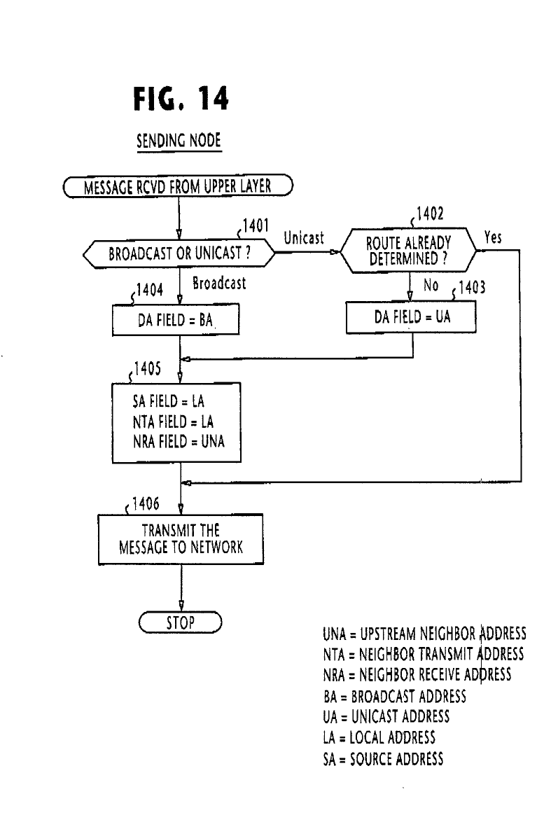

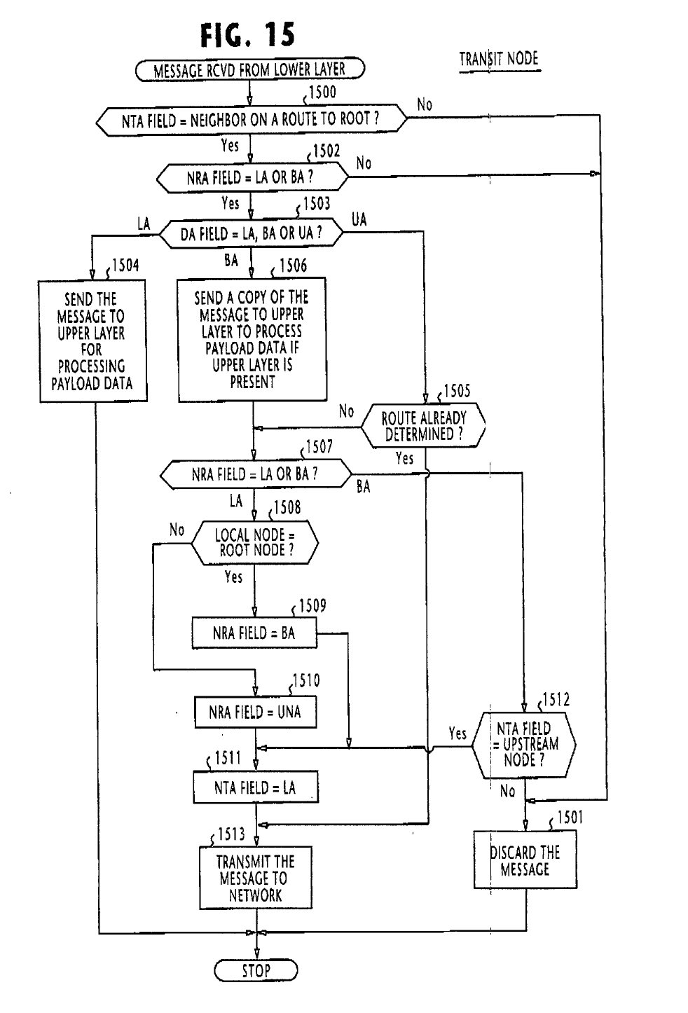

The flowcharts of a third embodiment of the present invention are shown in FIGS. 14 and 15.

This embodiment is particularly suited for application to a tree-topology wireless network where the wireless bridge 10 is the root node and all other nodes are downstream nodes, as illustrated in FIG. 1. In this embodiment, a broadcast message from a downstream node is transmitted upstream on a unicast mode to the root node. In response, the root node broadcasts the received message to all downstream nodes. However, each transit node may receive a broadcast message from downstream nodes as well as from upstream nodes. To prevent broadcast storm, each transit node forwards a broadcast message downstream if it receives the message from upstream neighbors, but discards all broadcast messages arriving from downstream neighbors. Note that the message format of FIG. 2 is used in this embodiment for transmission of broadcast messages.

In FIG. 14, the sending node begins its routine with step 1401 when a request for transmission of a message is received from the upper layer. If the message is a unicast message and the route of the message has been determined (1402), the message is transmitted in a unicast mode to the network (step 1406). If the route has yet to be determined, a unicast address is set into the DA field of the message (step 1403). If the message is a broadcast message (step 1401), the broadcast address is set into the DA field of the message (step 1404), At step 1405, the local address of the sending node is set into the SA (source address) and NTA (neighbor transmit address) fields of the message and the upstream neighbor address (UNA) is set into the NRA (neighbor receive address) field. The message is then transmitted to the network (step 1406).

In FIG. 15, each transit node of the network begins its routine with decision step 1500 to examine the NTA field of a message on receiving from the lower layer of the node and determines if the NTA field matches the address of a neighbor node located on a route to the root node. If not, the message is discarded (step 1501). Otherwise, flow proceeds to step 1502 to determine whether or not the NRA field matches the local address of the transit node or the broadcast address. If either of these addresses is not found in the NRA field, the message is discarded (step 1501). Otherwise, flow proceeds to step 1503 to determine if the DA field of the message matches the local address, the broadcast address or a unicast address. If the local address of the transit node is detected in the DA field, flow proceeds to step 1504 to send the message to the upper layer for processing the payload data. If the unicast address is detected in the DA field, flow proceeds from step 1503 to step 1505 to determine if the route of the unicast message has been determined. If so, flow proceeds to step 1513 to transmit the message to the network. If no route is determined, flow proceeds to decision step 1507.

If the broadcast address is detected in the DA field (step 1503), the transit node proceeds to step 1506 to send a copy of the message to the upper layer, if present, for processing the payload data. Therefore, if the local node is the root node, step 1506 is skipped.

At decision step 1507, the NRA field of the message is checked for NRA=LA or BA, If the message has arrived from a downstream rode, the NRA field of the message matches the local address of the transit node and flow proceeds from step 1507 to step 1508 to determine whether or not the local node is the root node. If the local node is the root node, the broadcast address is set into the NRA field of the message (step 1509) and the local address of the node is set into the NTA field (step 1511) and the message is transmitted from the root node downstream in broadcast mode (step 1513). If the local node is other than the root node, flow proceeds from step 1508 to step 1510 to set the upstream neighbor address into the NRA field and the local address into the NTA field (step 1511) and the message is transmitted from the branch node upstream in unicast mode (step 1513).

If the NRA field of the message matches the broadcast address (step 1507), it is determined that the message has arrived from an upstream node and flow proceeds to step 1512 to check to see if the NTA field matches the address of the upstream neighbor. If they match, flow proceeds to step 1511 to update the NTA field with the local address of the transit node and the message is transmitted downstream in broadcast mode (step 1513). If the transit node fails to detect the upstream neighbor address in the NTA field (step 1512), it determines that the broadcast message has arrived from a downstream neighbor and discards the message at step 1501.

In order to allow mobile nodes to receive the messages transmitted according to the flowchart of FIG. 15, the same process as described in connection with FIG. 8 is repeated.

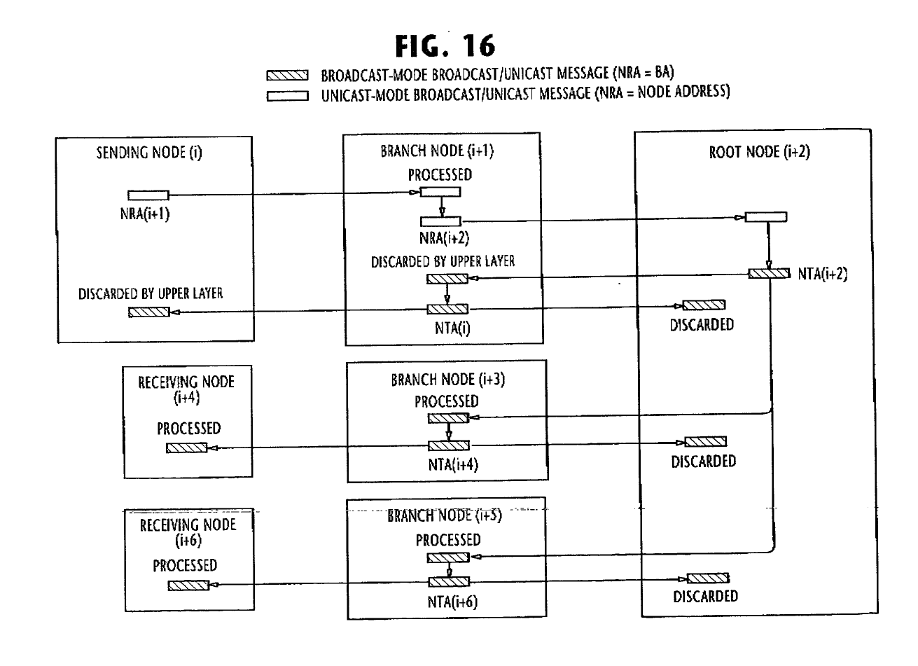

As schematically shown in FIG. 16, a unicast-mode message from a sending node (i) is received by a transit branch node (i+1). The received message is processed by the node (i+1) and transmitted to a root node (i+2) The root node updates the NRA field of the unicast message with the broadcast address (NRA=BA) and sets NTA=i+2 (i.e., the address i+2 of the root node is into the neighbor transmit address field of the message and broadcasts it downstream to all branch nodes (i+1), (i+3) and (i+5). Branch node (i+1) receives this message. However, the upper layer of this node discards this message. Then, the branch node (i+1) sets the NTA field equal to (i) and broadcasts this message. The broadcast message with NTA(i) is received by the sending node and discarded by the upper layer of he sending node. Further, the broadcast message with NTA(i) is received by the root node, but it determines that this message has arrived from a downstream node (step 1512) and discards it (step 1501).

In the branch nodes (i+3) and (i+5), each broadcast message from the root node is processed and their NTA fields are updated with the addresses of their downstream nodes (i+4) and (i+6) and broadcast. Nodes (i+4) and (i+6) process the received broadcast messages, and the root node discards the returning versions of the broadcast messages.

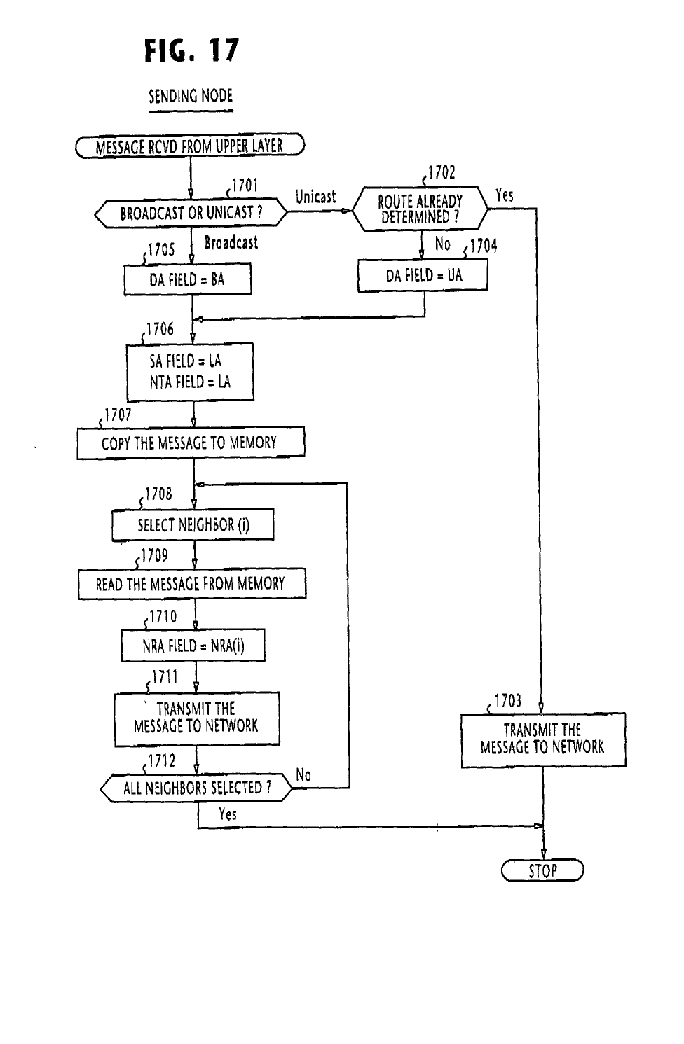

A fourth embodiment of the present invention is shown in FIGS. 17, 18 and 19. In this embodiment, broadcast messages and unicast messages are transmitted in a unicast mode until messages reach a leaf (peripheral) node of the network, whereupon the message is transmitted in a broadcast mode to mobile nodes.

In FIG. 17, the sending node begins its routine with step 1701 when a request for transmission of a message is received from the upper later. If the message is a unicast message and the route of the message has been determined (1702), the message is transmitted in a unicast mode to the network (step 1703). If the route has yet to be determined, a unicast address is set into the DA field of the message (step 1704). If the message is a broadcast message (step 1701), the broadcast address is set into the DA field of the message (step 1705). At step 1706, the local address of the sending node is set into the SA and NTA fields of the message. The message is then copied to a memory (step 1707). Then, the sending node enters a loop in which it selects the neighbor (i) of one of the routes to the destination (step 1708), reads the stored message from the memory (step 1709), sets the address (i) of the neighbor into the NRA field of the message (1710) and transmits the message to the network in a unicast mode (step 1711). Steps 1708, to 1711 are repeated until all neighbors of the sending node are selected and messages are transmitted to these neighbors (step 1712).

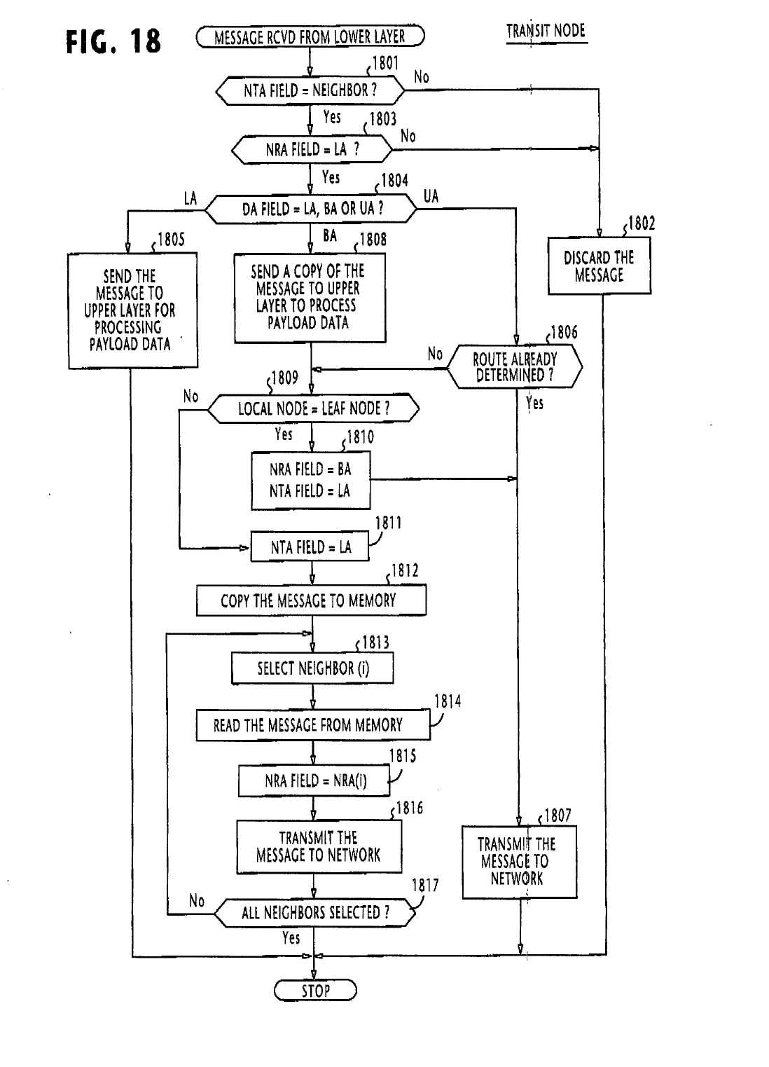

In FIG. 18, each transit node of the network begins its routine with decision step 1801 to examine the NTA field of a message upon receipt from the lower layer of the node and determines if the NTA field matches the address of a neighbor of the transit node. If not, the message is discarded (step 1802). Otherwise, flow proceeds to step 1803 to determine whether or not the NRA field matches the local address of the transit node. If the local address is not found in the NRA field, the message is discarded (step 1802). Otherwise, flow proceeds to step 1804 to determine if the DA field of the message matches the local address, the broadcast address or a unicast address. If the local address of the transit node is detected in the DA field, flow proceeds to step 1805 to send the message to the upper layer for processing the payload data. If the unicast address is detected in the DA field, flow proceeds from step 1804 to step 1806 to determine if the route of the unicast message has been determined. If so, flow proceeds to step 1807 to transmit the message to the network. If no route is determined, flow proceeds to decision step 1809.

If the broadcast address is detected in the DA field (step 1804), the transit node proceeds to step 1808 to send a copy of the message to the upper layer for processing the payload data, and proceeds to decision step 1809.

If the transit node is a leaf node, the decision at step 1809 is affirmative and the transit node sets the broadcast address into the NRA field of the message and its own local node address into the NTA field (step 1810) and transmits the message to the network (step 1807). If the transit node is other than a leaf node, flow proceeds from step 1809 to step 1811 to set the local address of the transit node into the NTA field of the message. This message is then copied to a memory (step 1812). Then, the transit node enters a loop in which it selects the neighbor (i) of one of all routes to the destination (step 1813), reads the stored message from the memory (step 1814), set the address (i) of the neighbor into the NRA field of the message (1815) and transmits the message to the network in a unicast mode (step 1816). Steps 1813 to 1816 are repeated until the neighbors of all routes except the one from which it has received the message are selected and messages are transmitted to these neighbors (step 1817).

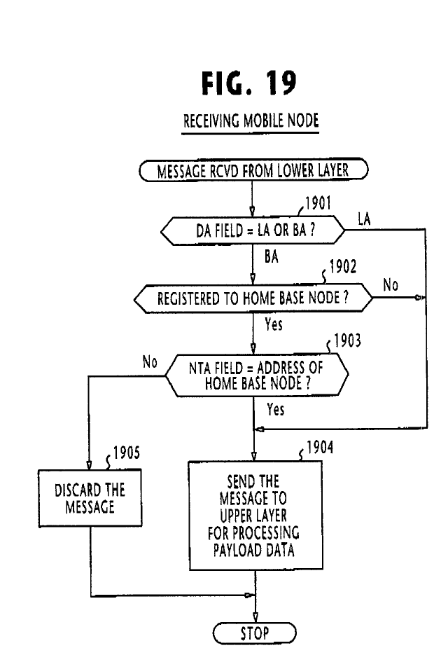

In FIG. 19, the routine of each mobile node of the network begins when a message is received from the lower layer. At decision step 1901, the receiving mobile node checks the DA field of the message for the presence of the local address or broadcast address. If the broadcast address is detected in the DA field, flow proceeds from step 1901 to step 1902 to determine if the mobile node has been registered in a base node. If not, the message is sent to the upper layer for processing the payload data (step 1904). This allows standby mobile nodes to receive broadcast messages. If the decision is affirmative at step 1902, flow proceeds to step 1903 to determine if the NTA field matches the address of the home base node. If this is the case, the message is sent to the upper layer (step 1904). If the decision at step 1903 is negative, flow proceeds to step 1905 to discard the message. If decision step 1901 indicates that the DA field matches the address of the mobile node, it is determined that the message is a unicast message and flow proceeds to step 1904 to send the message to the upper layer for processing its payload data.

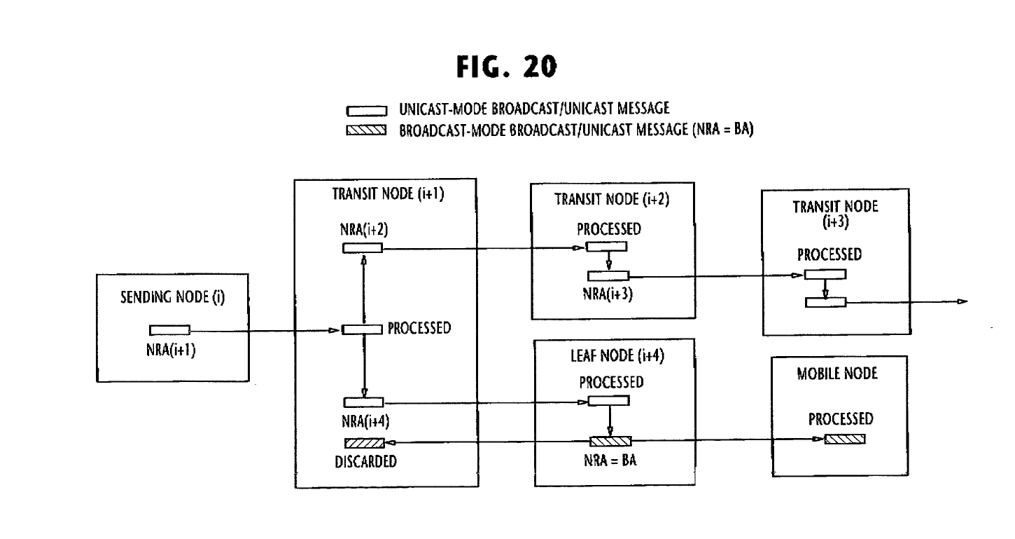

FIG. 20 shows a sequence of messages transmitted through the network according to the fourth embodiment of the invention. When a mobile node (i) sends a unicast-mode broadcast message, the NRA field contains the address of a transit base node (i+1). Upon receipt of this message, the transit node (i+1) processes the message and copies it into two messages with NRA=i+2 and NRA=i+4 and transmits them to a transit node (i+2) and a leaf node (i+4), respectively. Transit node (i+2) processes the received message and forwards a copy of this message to a next node by setting the NRA of the next node into the NRA field of the message, while the leaf node sets the broadcast address in the NRA field of the message and broadcasts the message. A mobile node receives this broadcast message for processing its payload data. This broadcast message may also be detected by the transit node (i+1). However, due to decision step 1803, this broadcast message is discarded to prevent further broadcasting of the message.

What is claimed is:

1. A multi-hop wireless communication network comprising:
a plurality of network nodes interconnected by a common wireless resource,
each of said network nodes, when functioning as a source node, formulating a message containing first and second address fields and a data payload field, said first address field identifying a neighbor node on a destination side of the network node and said second address field identifying a neighbor node on a source side of the network node, and transmitting the message; and
each of said network nodes, when functioning as a transit node, discarding the message depending on at least one of the first and second address fields of the message, updating said first and second address fields according to neighbor nodes of the transit node, and broadcasting the message using said common wireless resource.

2. A multi-hop wireless communication network comprising:
a plurality of network nodes for establishing a wireless link between neighboring network nodes over a common wireless resource;
each of said network nodes, when functioning as a source node, broadcasting a first message and unicasting a second message; and
each of said network nodes, when functioning as a transit node, receiving said first and second messages, discarding the received first message, producing a copy of the first message from the received second message, broadcasting the copy of the first message, and unicasting the received second message.

3. The multi-hop wireless communication network of claim 2, wherein said transit node processes the received second message and wherein each of said network nodes, when functioning as a destination node, receives and processes payload data of said copy of the first message and discards said second broadcast message.

4. A multi-hop wireless communication network comprising:
a plurality of network nodes for establishing a wireless link between neighboring network nodes over a common wireless resource, each of said nodes being identified by an address;
each of said network nodes, when functioning as a source node, broadcasting a message containing a previous hop address; and
each of said network nodes, when functioning as a transit rode, (a) receiving said message, (b) discarding the received message if the previous hop address of the received message is equal to the address of the transit node or updating the previous hop address of the received message with the address of a previous node if the previous hop address of the received message is not equal to the address of the transit node and (c) broadcasting the updated message.

5. The multi-hop wireless communication network of claim 4, wherein the transit node processes payload data of the received message and wherein each of said network nodes, when functioning as a destination node, receives and processes payload data of the broadcast updated message.

6. A multi-hop wireless communication network comprising:
a plurality of network nodes of a tree topology configuration for establishing a wireless link between neighboring network nodes over a common wireless resource, each of said nodes being identified by an address, and one of said nodes being a root node;
each of said network nodes, when functioning as a source node, unicasting a message toward the root node, the message containing a unicast address;
each of said network nodes, when functioning as a branch node, updating the unicast address of the unicast message and unicasting the updated message toward the root node;
said root node being responsive to the message from the branch node, updating the message with a broadcast address and the address of the root node, and broadcasting the updated message; and
said branch node receiving the broadcast message, updating the broadcast message with the address of the branch node and broadcasting the updated message.

7. The multi-hop wireless communication network of claim 6, wherein said branch node processes payload data of the message received from the source node, and wherein each of said network nodes, when functioning as a destination node, receives and processes payloads data of the broadcast message from said branch node.

8. The multi-hop wireless communication network of claim 7, wherein said branch node processes the message received from the root node.

9. A multi-hop wireless communication network comprising:
a plurality of network nodes for establishing a wireless link between neighboring network nodes over a common wireless resource, each of said nodes being identified by an address;
each of said network nodes, when functioning as a source node, unicasting a message containing a unicast address;
each of said network nodes, when functioning as a transit node, receiving the message, updating the unicast address of the message with the address of a next node if the transit node is other than a leaf node and unicasting the updated message to the next node, updating the unicast address of the received message with a broadcast address if the transit node is a leaf node and broadcasting the updated message; and
said transit node discarding the received message if said transit node is a neighbor of said leaf node.

10. The multi-hop wireless communication network of claim 9, wherein said transit node processes the received message, and wherein each of said network nodes, when functioning as a destination node, receives and processes payload data of said broadcast message from the leaf node.

11. A method of communication for a multi-hop wireless communication network, wherein a plurality of network nodes are interconnected by a common wireless resource, the method comprising the steps of;
at a source node,
formulating a message containing first and second address fields and a data payload field, said first address field identifying a neighbor node on a destination side of the network node and said second address field identifying a neighbor node on a source side of the network node; and
transmitting the message toward a destination node, and at a transit node,
discarding the message depending on at least one of the first and second address fields of the message;
updating said first and second address fields according to neighbor nodes of the transit node; and
broadcasting the message using said common wireless resource.

12. A method of communication for a multi-hop wireless communication network, wherein the network comprises a plurality of network nodes each being identified by an address, comprising the steps of:
a) at a source node, broadcasting a first message and unicasting a second message using a common wireless resource; and
b) at a transit node, receiving the first and second messages, discarding said first message, producing a copy of the first message from the second message, broadcasting the copy of the first message and unicasting the second message using said common wireless resource.

13. The method of claim 12, further comprising the steps of receiving and processing payload data of said copy of the first message at a destination node, and discarding the unicast second message.

14. The method of claim 12, wherein the step (a) further comprises the steps of:
a₁) selecting a neighbor node of the source node;
a₂) formulating a message with the address of the neighbor node of said selected route;
a₃) unicasting the message formulated by step (a₂) as said second message; and
a₄) repeating steps (a₁) to (a₃) until the second message is unicast to all neighbor nodes of the source node.

15. The method of claim 13, wherein the step (b) further comprises the steps of:
b₁) selecting a neighbor node of the transit node;
b₂) formulating a message with the address of the neighbor node of said selected route;
b₃) unicasting the message formulated by step (b₂) as said second message; and
b₄) repeating steps (b₁) to (b₃) until the second message is unicast to all neighbor nodes of the transit node.

16. The method of claim 12, wherein the first message includes a destination address (DA) field containing a broadcast address (BA) and a neighbor receive address (NRA) field containing said broadcast address (BA), and the second message includes a destination address (DA) field containing said broadcast address (BA) and a neighbor receive ad dress (NRA) field containing the address of a neighbor node of the source node,
wherein the step (b) comprises the steps of:
b₁) examining the NRA field of a received message;
b₂) discarding the message if the address contained in the examined NRA field is other than the address of the transit node;
b₃) examining the DA field of the received message if the NRA field of the received message is the address of the transit node;
b₄) broadcasting a copy of the received message with the NRA field being containing the broadcast address;
b₅) selecting a neighbor node;
b₆) transmitting a copy of the received message with the NRA field being containing the address of the selected neighbor node; and
b₇) repeating steps (b₅) and (b₆) until said copy of the received message is transmitted to all neighbors of the transit node.

17. The method of claim 13, wherein the message includes a destination address (DA) field and a neighbor transmit address (NTA) field containing the address of a neighbor node of the destination node, further comprising the steps of:
if the DA field of the received message is a broadcast address, determining whether the destination node is registered to a home node;
if the destination node is not registered to a home node, processing payload data of the message;
if the destination node is registered to a home node, examining the NTA field of the received message; and
if the NTA field of the message contains the address of a neighbor node of the destination node, processing the received message.

18. A method of communication for a multi-hop wireless communication network, wherein the network comprises a plurality of network nodes each being identified by an address, comprising the steps of:
a) at a source node, broadcasting a message containing a previous hop address by using a common wireless resource;
b) at a transit node,
(b₁) responsive to receipt of said message, discarding the message if the previous hop address of the received message is equal to the address of the transit node or updating the previous hop address of the received message with the address of a previous node if the previous hop address of the received message is not equal to the address of the transit node, and
(b₂) broadcasting the updated message by using said common wireless resource.

19. The method of claim 18, wherein the step (b₁) further comprises the step of processing payload data of the received message, further comprising the step of receiving the broadcast updated message and processing payload data of the received message at a destination node.

20. The method of claim 18, wherein the message further includes a neighbor transmit address (NTA) field containing the address of a neighbor node from which the transit node received the message, wherein the step (b2) further comprises the step of discarding the message if the NTA field contains the address of a node other than a neighbor of the transit node.

21. The method of claim 19, wherein the message includes a destination address (DA) field and a neighbor transmit address (NTA) field containing the address of a neighbor node of the destination node, further comprising the steps of:
if the DA field of the received message is a broadcast address, determining whether the destination node is registered to a home node;
if the destination node is not registered to a home node, processing payload data of the message;
if the destination node is registered to a home node, examining the NTA field of the received message; and
if the NTA field of the message contains the address of a neighbor node of the destination node, processing the received message.

22. A method of communication for a multi-hop wireless communication network, wherein the network comprises a plurality of network nodes of a tree topology configuration, each being identified by an address and one of said nodes being a root node, comprising the steps of:
a) at a source node, unicasting a message toward the root node by using a common wireless resource, the message containing a unicast address;
b) at a first branch node, updating the unicast address of the unicast message and unicasting the updated message toward the root node by using said common wireless resource;
c) at said root node, responsive to the message from the branch node, updating the message with a broadcast address and the address of the root node, and broadcasting the updated message by using said common wireless resource; and
d) at a second branch node receiving the broadcast message, updating the broadcast message with the address of the second branch node and broadcasting the updated message by using said common wireless resource.

23. The method of claim 22, wherein the step (b) further comprises the step of processing payload data of the message received from the source node and the step (d) further comprises the step of processing payload data of the message received from the root node, further comprising the step of receiving at a destination node and processing payload data of the broadcast message from said branch node.

24. The method of claim 23, wherein the message includes a destination address (DA) field and a neighbor transmit address (NTA) field containing the address of a neighbor node of the destination node further comprising the steps of;
if the DA field of the received message is a broadcast address, determining whether the destination node is registered to a home node;
if the destination node is not registered to a home node, processing payload data of the message;
if the destination node is registered to a home node, examining the NTA field of the received message; and
if the NTA field of the message contains the address of a neighbor node of the destination node, processing the received message.

25. A method of communication for a multi-hop wireless communication network, wherein the network comprises a plurality of network nodes each being identified by an address, comprising the steps of:
a) at a source node, unicasting a message containing a unicast address; and
b) at a transit node,
b₁) responsive to receipt of said message, updating the unicast address of the message with the address of a next node if the transit node is other than a leaf node;
b₂) unicasting the updated message to the next node;
b₃) if the transit node is a leaf node, updating the unicast address of the received message with a broadcast address and broadcasting the updated message; and
b₄) if the transit node is a neighbor of said leaf node, discarding the broadcast message from the leaf node.

26. The method of claim 25, wherein the step (b₁) further includes the step of processing payload data of the received message, further comprising the step of receiving, at a destination node, and processing payload data of said broadcast message from the leaf node.

27. The method of claim 26, wherein the message includes a destination address (IDA) field and a neighbor transmit address (NTA) field containing the address of a neighbor node of the destination node, further comprising the steps of:
if the DA field of the received message is a broadcast address, determining whether the destination node is registered to a home node;
if the destination node is not registered to a home node, processing payload data of the message;
if the destination node is registered to a home node, examining the NTA field of the received message; and
if the NTA field of the message contains the address of a neighbor node of the destination node, processing the received message.

28. A network node for a multi-hop wireless communication network, wherein said network node is one of a plurality of network nodes of said communication network, and wherein said network nodes establish a wireless link between neighbor nodes over a common wireless resource, comprising the functions of:
when functioning as a source node, broadcasting a first message and unicasting a second message; and
when functioning as a transit node, receiving said first and second messages, discarding the received first message, producing a copy of the first message from the received second message, broadcasting the copy of the first message, and unicasting the received second message.

29. A network node for a multi-hop wireless communication network wherein said network node is one of a plurality of network nodes of said communication network, and wherein said network nodes establish a wireless link between neighbor nodes over a common wireless resource, comprising the functions of:
when functioning as a source node, broadcasting a message containing a previous hop address; and
when functioning as a transit node, (a) receiving said message, (b) discarding the received message if the previous hop address of the received message is equal to the address of the transit node or updating the previous hop address of the received message with the address of a previous node if the previous hop address of the received message is not equal to the address of the transit node and (c) broadcasting the updated message.

30. A network node for a multi-hop wireless communication network of a tree topology configuration, wherein said network node is one of a plurality of network nodes of said network, and wherein said network nodes establish a wireless link between neighbor nodes over a common wireless resource, each of said nodes being identified by an address, and one of said nodes being a root node, the network node comprising the functions of:
when functioning as a source node, unicasting a message toward the root node, the message containing a unicast address;
when functioning as a branch node, updating the unicast address of the unicast message and unicasting the updated message toward the root node;
when functioning as said root node, responsive to the message from the branch node, updating the message with a broadcast address and the address of the root node, and broadcasting the updated message; and
when functioning as said branch node, receiving the broadcast message, updating the broadcast message with the address of the branch node and broadcasting the updated message.

31. A network node for a multi-hop wireless communication network wherein said network node is one of a plurality of network nodes of said communication network, and wherein said network nodes establish a wireless link between neighbor nodes over a common wireless resource, comprising the functions of:
when functioning as a source node, unicasting a message containing a unicast address;
when functioning as a transit node, receiving the message, updating the unicast address of the message with the address of a next node if the transit node is other than a leaf node and unicasting the updated message to the next node, updating the unicast address of the received message with a broadcast address if the transit node is a leaf node and broadcasting the updated message; and
when functioning as said transit node, discarding the receiver message if said transit node is a neighbor of said leaf node.

32. A storage medium for storing a computer program for a network node of a multi-hop wireless communication network, wherein said network node is one of a plurality of network nodes of said communication network, and wherein said network nodes establish a wireless link between neighbor nodes over a common wireless resource, said computer program comprising the steps of:
broadcasting a first message and unicasting a second message when said network node is functioning as a source node;
receiving said first and second messages when the network node is functioning as a transit node;
discarding the received first message;
producing a copy of the first message from the received second message;
broadcasting the copy of the first message; and
unicasting the received second message.

33. A storage medium for storing a computer program for a network node of a multi-hop wireless communication network, wherein said network node is one of a plurality of network nodes of said communication network, and wherein said network nodes establish a wireless link between neighbor nodes over a common wireless resource, said computer program comprising the steps of:
broadcasting a message containing a previous hop address when the network node is functioning as a source node;
receiving said message when the network node is functioning as a transit node;
discarding the received message if the previous hop address of the received message is equal to the address of the transit node or updating the previous hop address of the received message with the address of a previous node if the previous hop address of the received message is not equal to the address of the transit node; and
broadcasting the updated message.

34. A storage medium for storing a computer program for a network node of a multi-hop wireless communication network of a tree topology configuration, wherein said network node is one of a plurality of network nodes of said communication network, and wherein said network nodes establish a wireless link between neighbor nodes over a common wireless resource, each of said nodes being identified by an address, and one of said nodes being a root node, said computer program comprising the steps of:
unicasting a message toward the root node, the message containing a unicast address when the network node is functioning as a source node;
updating the unicast address of the unicast message and unicasting the updated message toward the root node when the network node is functioning as a branch node;
responsive to the message from the branch node, updating the message with a broadcast address and the address of the root node, and broadcasting the updated message when the network node is functioning as said root node; and
receiving the broadcast message, updating the broadcast message with the address of the branch node and broadcasting the updated message when the network node is functioning as said branch node.

35. A storage medium for storing a computer program for a network node of a multi-hop wireless communication network, wherein said network node is one of a plurality of network nodes of said communication network, and wherein said network nodes establish a wireless link between neighbor nodes over a common wireless resource, said computer program comprising the steps of:
unicasting a message containing a unicast address when the network node is functioning as a source node;
receiving the message when the network node is functioning as a transit node, updating the unicast address of the message with the address of a next node if the transit node is other than a leaf node and unicasting the updated message to the next node, updating the unicast address of the received message with a broadcast address if the transit node is a leaf node and broadcasting the updated message; and
discarding the received message when the network node is functioning as said transit node if said transit node is a neighbor of said leaf node.
